(19) United States
(12) Patent Application Publication
(10) Pub. No.: US 2008/0011709 A1
(43) Pub. Date: Jan. 17, 2008

(54) POLYETHYLENE-BASED RESIN MOLDING MATERIAL

(75) Inventors: Kunihiko IBAYASHI, Kanagawa (JP); Ippei Kagaya, Kanagawa (JP); Tomomi Hiramoto, Kanagawa (JP); Kazuyuki Shimada, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JAPAN POLYETHYLENE CORPORATION, Tokyo (JP)

(21) Appl. No.: 11/767,043

(22) Filed: Jun. 22, 2007

(30) Foreign Application Priority Data
Jul. 14, 2006 (JP) 2006-194941

(51) Int. Cl. B65D 41/00; C08L 23/08

(52) U.S. Cl. 215/316; 525/240

(57) ABSTRACT

A polyethylene-based resin molding material having an ethylene-based polymer in an amount from ≧20% to <30% by weight that has a high load melt flow rate (HLMFR) at a temperature of 190° C. under a load of 21.6 kg of 0.1 to 1.0 g/l0 min and a density of 0.910 to 0.930 g/cm3; and an ethylene-based polymer in an amount from >70% to ≦80% by weight that has a melt flow rate (MFR) at a temperature of 190° C. under a load of 2.16 kg of ≧150 g/10 min to <400 g/10 min and a density of ≧0.960 g/cm3; and wherein the polyethylene-based resin molding material has an MFR from ≧0.4 g/10 min to <2.0 g/10 min, an HLMFR from ≧70 g/10 min to <180 g/10 min, an HLMFR/MFR of 100 to 200, and a density from ≧0.953 g/cm3 to <0.965 g/cm3.

### FIELD OF THE INVENTION

The present invention relates to a polyethylene-based resin molding material. More specifically, it relates to a polyethylene-based resin molding material for a container and for a container closure, which is suitable for containing a liquid such as a drink, particularly a liquid of a carbonated drink. In particular, it relates to a polyethylene-based resin molding material suitable for a container closure, which is on the whole excellent in higher productivity at molding, high melt flow, rigidity, impact resistance, stress crack resistance, slipping ability, good organoleptics, food safety, easy opening property, easy closing property and the like, and is good in long-term durability even at high temperature.

### BACKGROUND ART

Plastic containers are excellent in various physical properties, moldability, lightness, economic efficiency, and the like and further are suitable for reusability and the like for dealing environmental problems, they have been widely employed in recent years as daily necessities and industrial goods with surpassing conventional containers made of metals, glass, and the like. Among the plastic containers, so-called PET bottles (containers made of polyethylene terephthalate) are in great demand as containers for drinks owing to their excellent mechanical strength, transparency, high gas-shielding ability, no-polluting property, and the like since they have been approved as containers for foods and drinks. In particular, small-size PET bottles are taken into confidence of consumers as portable small-size containers for drinks. Also, thermal resistance and pressure resistance of the PET bottles are improved and hence the bottles have been widely used as containers for portable hot drinks in winter and for high-temperature sterilized drinks for long-term storage.

As well as the polyester resin represented by the PET bottles, polyethylene-based resins are also recognized as important materials for containers for drinks and demand therefor has been increasing.

Moreover, in the containers made of PET as containers for drinks such as carbonated drinks, caps made of aluminum metal have hitherto been used as container closures thereof. However, recently, from the viewpoint of environmental conservation such as recycling and economic efficiency, caps made of polyolefin have increasingly employed.

Cap members of containers for drinks and the like are products as important as the containers per se in view of essential performances such as sealing ability, easy opening property, safety of foods and drinks, and durability. From the viewpoints of various physical properties such as moldability, rigidity, and thermal resistance as well as the above performances, on the cap members made of polyolefin, particularly made of polyethylene-based resin, investigation for technical improvement thereof has been continuously performed and a large number of proposals for the improvement have been disclosed in patent publications laid-open to public.

Among them, the following will survey representative proposals for the improvement. Patent Document 1 discloses a polyethylene resin composition wherein MFR (melt flow rate) and density of the polyethylene component are defined in order to improve pressure resistance and gas-sealing ability with regard to caps for containers for carbonated drinks. Patent Document 2 discloses an ethylene-based resin composition for injection molding comprising an ethylene/α-olefin copolymer wherein MFR, density, and maximum melting peak temperature are defined and a specific additive such as a glycerin fatty acid ester. However, the composition disclosed in Patent Document 1 contains too small amount of low-molecular-weight components and hence higher productivity is insufficient. Also, the composition disclosed in Patent Document 2 contains a specific additive component for improving mold-releasing ability, so that the composition is not satisfactory in view of food safety owing to component elution.

In order to shorten a molding cycle of a container closure and enhance production efficiency together with improvement of various performances such as sealing ability and rigidity, attempts of injection molding and continuous compression molding using highly fluid polyolefin resins have been made. Patent Documents 3 and 4 disclose polyethylene-based resin materials wherein MFR and FLR (flow ratio) of MFR are defined in the resin itself or a composition. However, since the resin material disclosed in Patent Document 3 has a high MFR, impact resistance is insufficient. The resin material disclosed in Patent Document 4 includes problems of crack formation during warehouse storage at high temperature in summer and stress-relaxation owing to insufficient tensile yield stress.

Form the viewpoint of filling a content liquid into a container, there has been adopted a method of filling the content liquid into the container directly in a state where the container is just sterilized by heating. In recent years, using a container which is washed beforehand, a method of filling the content liquid into the container in a clean room (aseptic filling method) has begun to be employed. Patent Documents 5 and 6 propose, as polyethylene resins for use in such container closures, resin materials free from odor and strange-taste components and having long-term storability of flavor wherein MFR and density of the resin materials and monodispersity of molecular weight are defined. However, in Patent Documents 5 and 6, although low odor property and good organoleptics are achieved, there is no disclosure as suitable materials satisfying many physical properties required for container closures.

Nowadays, for the reason of enhancing economical efficiency, the thickness of container closures has been thinned together with higher output at molding wherein molding speed is fastened. In the thinning of the container closures, higher rigidity is required in order to prevent deformation of the container closures by inner pressure of the containers to leak the content from the sealed portions. In particular, recently, there appears a situation that a container having a drink such as green tea therein is sold under heating in a heating chamber. In the sale under heating, higher rigidity is further required so that the shape thereof is maintained even under high temperature and no crack is formed by screwing up the container closure. Accordingly, Patent Document 7 discloses a material exhibiting a small elongation of the resin even at high temperature and improving re-easy closing property together with improvement of various performances such as moldability and stress crack resistance, wherein density and MFR and FLR of MFR of the resin material are defined. Patent Document 8 discloses a material excellent in size stability during storage under heating together with various performance such as rigidity and impact resistance, wherein density and MFR of the composition are defined. However, in the container closures for carbonated drinks, because of the large inner pressure, stress may be generated and a crack may be formed owing to insufficient stress crack resistance in the above materials. Thus, there is required further improvement in container closures for carbonated drinks having a sufficient balance of rigidity and stress crack resistance.

Incidentally, the polyethylene-based resin materials disclosed in Patent Document 4 and Patent Document 9 proposing a material wherein density, MFR, FLR of MFR, and further the number of short-chain branches of the resin material are defined can realize materials possessing various performances such as thermal resistance, rigidity, moldability, and stress crack resistance, so that polyethylene-based resin materials capable of enduring the inner pressure of carbonated drinks have begun to be used as container closures for carbonated drinks. Moreover, Patent Document 10 discloses a polyethylene-based resin material excellent in long-term storage of a container content, wherein MFR and density of the resin material and monodispersity of the molecular weight are defined. However, for any of these materials, further improvement of stress crack resistance against the inner pressure of carbonated drinks is required in order to prevent crack formation during warehouse storage at high temperature in summer.

Furthermore, in the polyethylene-based resin materials as container closure materials, in addition to conventionally required various characteristic properties, improvement of FNCT performance (time for break in full notch creep test) is also required. In particular, improvement of tensile strength at yield, which relates to loosening of caps owing to insufficient tensile strength at yield, is also desired. The tensile strength at yield closely correlates to loosening of container closures. When the tensile strength at yield is low, the container closures are apt to be loosened and easy closing property of container closures, which should have an appropriate hardness, is insufficient. For improving the stress crack resistance of the container closures, it is necessary to lower the density of the polyethylene-based material and hence it is hitherto difficult to enhance the tensile strength at yield with improving the stress crack resistance.

In the conventional technologies in the above, the cap members of containers are formed of polyethylene-based resin materials or compositions thereof, there is an attempt of improving the performance of the cap member with a laminated material of a polyethylene-based resin material. For example, Patent Document 11 discloses a laminated cap member wherein a sheet obtained by laminating a composition of a polyolefin and an oxygen absorber onto a polyolefin layer is overlaid on a foam layer, which aims at a specific oxygen absorbability together with sealing ability and flavor-retaining ability.

Thus, the conventional improving technologies have intended to improve a number of performances, i.e., moldability, fluidity, rigidity, impact resistance, and the like as well as performances such as sealing ability and easy opening property of the container, safety of foods and drinks, durability, stress crack resistance, and thermal resistance, which are desired for cap members of polyethylene-based resin materials in the containers for drinks. However, it is a current situation that any improving proposal of improving these performances in a good balance is not yet found.

In recent years, as improving technologies aiming at improvement of these performances in a good balance, Patent Document 12 proposes a polyethylene-based resin composition wherein density, MFR, folding endurance, tearing strength, volatile matter content, and Vicat softening point, and the like are defined and Patent Document proposes a polyethylene-based resin material wherein density, MFR, and FLR as well as flexural modulus and constant strain ESCR of an injection-molded sample are defined.
[Patent Document 1] JP-A-58-103542 (cf., abstract)
[Patent Document 2] JP-A-8-302084 (cf., abstract)
[Patent Document 3] JP-A-2000-159250 (cf., abstract)
[Patent Document 4] JP-A-2000-248125 (cf., abstract)
[Patent Document 5] JP-A-2002-249150 (cf., abstract)
[Patent Document 6] JP-A-2005-307002 (cf., abstract)
[Patent Document 7] JP-A-2004-123995 (cf., abstract)
[Patent Document 8] JP-A-2004-244557 (cf., abstract)
[Patent Document 9] JP-A-2002-60559 (cf., abstract)
[Patent Document 10] JP-A-2001-180704 (cf., abstract)
[Patent Document 11] JP-A-2000-264360 (cf., abstract)
[Patent Document 12] JP-A-2005-60517 (cf., abstract)
[Patent Document 13] JP-A-2005-320526 (cf., abstract)

### SUMMARY OF THE INVENTION

In consideration of the background art as outlined above, it is a current situation that there has been not yet disclosed an improving proposal of improving a number of the performances, which are desired for the polyethylene-based resin materials for cap members in thermoplastic resin containers for drinks and the like, in a good balance on the whole. Accordingly, a problem that the invention is to solve is to develop a polyethylene-based resin material which is excellent in various performances such as higher productivity, high melt flow, rigidity, impact resistance, durability, thermal resistance, slipping ability, low odor property, and food safety in a good balance on the whole, is also satisfactory in easy opening property and sealing ability, and also has improved mechanical properties such as stress crack resistance under the pressure of a carbonated drink during handling at high temperature, FNCT break performance, and tensile strength at yield.

In order to solve such a problem of the invention, the present inventors have considered MFR and HLMFR of polyethylene-based resins, and FLR thereof, relation between numeral values thereof and resin density, correlation of various performances of cap materials with individual numeral value installation, and furthermore performances as compositions in case of combining individual resin materials, for the purpose of finding the above-mentioned novel polyethylene-based resin material for a container closure in consideration of empirical rules on circumstances of conventional improving technologies in the polyethylene-based resin materials for container closures, and they have experimentally tried and investigated on the above. As a result thereof, they have found a novel composition material comprising a combination of specific resin materials, which constitutes the invention.

The polyethylene-based resin material of the invention is a molding material suitable for a cap member for containers such as containers for drinks, which is a combination of two kinds of specific polyethylene-based resins, possesses properties as a composition therein, and can be also used as a material for a container per se for drinks and the like.

In the invention, a polyethylene-based resin molding material for a container and for a container closure is provided wherein, as a component (A), an ethylene-based polymer having a high load melt flow rate (HLMFR) at a temperature of 190° C. under a load of 21.6 kg of 0.1 to 1.0 g/10 min and a density of 0.910 to 0.930 g/cm³ and, as a component (B), an ethylene-based polymer having a melt flow rate (MFR) at a temperature of 190° C. under a load of 2.16 kg of 150 g/10 min or more and less than 400 g/10 min and a density of 0.960 g/cm³ or more are combined to form a composition comprising the component (A) in an amount of 20% by weight or more and less than 30% by weight and the component (B) in an amount of more than 70% by weight and 80% by weight or less, and further the composition possesses two characteristic properties: characteristic property (1): an MFR of 0.4 g/10 min or more and less than 2.0 g/10 min, an HLMFR of 70 g/10 min or more and less than 180 g/10 min, and an HLMFR/MFR (flow ratio) of 100 to 200; and characteristic property (2): a density of 0.953 g/cm³ or more and less than 0.965 g/cm³.

As a result of possessing such specific constitutional requirements, the composition material of the invention is a polyethylene-based resin molding material which can realize improvement of a large number of the performances, which are desired for the polyethylene-based resin materials for cap members in thermoplastic resin containers for drinks and the like, in a good balance on the whole and which is excellent in various performances such as higher productivity, high melt flow, rigidity, impact resistance, durability, thermal resistance, slipping ability, low odor property, and food safety in a good balance on the whole, is also satisfactory in easy opening property and sealing ability, and further has improved mechanical properties such as stress crack resistance under the pressure of a carbonated drink during handling at high temperature, FNCT break performance, and tensile strength at yield.

In particular, the improvement of the mechanical properties such as stress crack resistance, FNCT break performance, and tensile strength at yield which are important performances as a cap material for carbonated drinks, is evidenced by comparing data of Examples and Comparative Examples to be described later.

In the invention, as additional requirements, there may be defined characteristic property (3): a flexural modulus of 800 MPa or more; and characteristic property (4): a tensile strength at yield of 25 MPa or more; and also there may be defined that the ethylene-based polymer is a copolymer of ethylene and an α-olefin, and a hydrocarbon volatile matter content is 80 ppm or less.

Furthermore, it is also a characteristic that the composition constituting the polyethylene-based resin molding material is produced by sequential multistage polymerization of ethylene or ethylene and an α-olefin, without limitation to a mixing method of individual components.

In the above, the circumstances of creating the invention and fundamental constitution and characteristics of the invention are outlined. Now, when the overall constitution of the invention is reviewed, the invention comprises the following inventive unit groups. The molding material in [1] is constituted as a fundamental invention and each invention of [2} or the following may add an additional requirement to the fundamental invention or represents an embodiment thereof. In this connection, all the inventive units are collectively referred to as an invention group.

[1] A polyethylene-based resin molding material, which is a composition comprising: the following component (A) in an amount of 20% by weight or more and less than 30% by weight; and the following component (B) in an amount of more than 70% by weight and 80% by weight or less, wherein the polyethylene-based resin molding material satisfies the following characteristic properties (1) and (2):

component (A): an ethylene-based polymer having a high load melt flow rate (HLMFR) at a temperature of 190° C. under a load of 21.6 kg of 0.1 to 1.0 g/10 min and a density of 0.910 to 0.930 g/cm³;

component (B): an ethylene-based polymer having a melt flow rate (MFR) at a temperature of 190° C. under a load of 2.16 kg of 150 g/10 min or more and less than 400 g/10 min and a density of 0.960 g/cm³ or more, characteristic property(l): an MFR of 0.4 g/10 min or more and less than 2.0 g/10 min, an HLMFR of 70 g/10 min or more and less than 180 g/10 min, and an HLMFR/MFR of 100 to 200;

characteristic property(2): a density of 0.953 g/cm³ or more and less than 0.965 g/cm³.

[2] The polyethylene-based resin molding material in [1], which satisfies the following characteristic properties (3) and (4):

characteristic property (3): a flexural modulus of 800 MPa or more;

characteristic property (4): a tensile strength at yield of 25 MPa or more.

[3] The polyethylene-based resin molding material in [1] or [2], wherein the ethylene-based polymer (A) is a copolymer of ethylene and an α-olefin.

[4] The polyethylene-based resin molding material in any one of [1] to [3], which has a hydrocarbon volatile matter content of 80 ppm or less.

[5] The polyethylene-based resin molding material in any one of [1] to [4], wherein the composition constituting the polyethylene-based resin molding material is produced by sequential multistage polymerization of ethylene or ethylene and an α-olefin.

[6] A container closure, which comprises the polyethylene-based resin molding material in any one of [1] to [5].

[7] The container closure in [6], wherein the container closure is a cap for a container for a carbonated drink.

According to the invention, there can be obtained a polyethylene-based resin molding material which is suitable for a container closure for placing a liquid such as a drink and which is excellent in various performances such as higher productivity, high melt flow, rigidity, impact resistance, durability, thermal resistance, slipping ability, low odor property, and food safety in a good balance on the whole, is satisfactory in easy opening property and sealing ability, and further has improved mechanical properties such as stress crack resistance under the pressure of a carbonated drink during handling at high temperature, FNCT break performance, and tensile strength at yield.

### DETAILED DESCRIPTION OF THE INVENTION

The above describes summary of the invention and fundamental constitution and characteristics of the invention. The following will specifically describe embodiments of the invention as the best mode for carrying out the invention for explaining the whole of the invention group of the invention in detail.

1. Polyethylene-based Resin Molding Material

(1) Constitution as Composition

The polyethylene-based resin molding material of the invention is constituted as a composition from two or more kinds of ethylene-based polymers and is a polyethylene-based resin molding material for a container and for a container closure, which is a composition comprising: the following component (A) in an amount of 20% by weight or more and less than 30% by weight; and the following component (B) in an amount of more than 70% by weight and 80% by weight or less, wherein the polyethylene-based resin molding material satisfies the following characteristic properties (1) and (2):

component (A): an ethylene-based polymer having a high load melt flow rate (HLMFR) at a temperature of 190° C. under a load of 21.6 kg of 0.1 to 1.0 g/10 min and a density of 0.910 to 0.930 g/cm³;

component (B): an ethylene-based polymer having a melt flow rate (MFR) at a temperature of 190° C. under a load of 2.16 kg of 150 g/10 min or more and less than 400 g/10 min and a density of 0.960 g/cm³ or more, characteristic property(l): an MFR of 0.4 g/10 min or more and less than 2.0 g/10 min, an HLMFR of 70 g/10 min or more and less than 180 g/10 min, and an HLMFR/MFR of 100 to 200;

characteristic property(2): a density of 0.953 g/cm³ or more and less than 0.965 g/cm³.

(2) Requirements of Individual Components

The HLMFR of the ethylene-based polymer of the component (A) is 0.1 to 1.0 g/10 min, preferably 0.1 to 0.8 g/10 min, further preferably 0.1 to 0.5 g/10 min. When the HLMFR of the component (A) is less than 0.1 g/10 min, there is a tendency that fluidity decreases and moldability becomes worse. When it exceeds 1.0 g/10 min, stress crack resistance tends to decrease.

The density of the component (A) is 0.910 to 0.930 g/cm³, preferably 0.915 to 0.925 g/cm³, further preferably 0.915 to 0.920 g/cm³. When the density of the component (A) is less than 0.910 g/cm³, rigidity becomes insufficient. When it exceeds 0.930 g/cm³, stress crack resistance tends to decrease.

In this connection, the MFR, HLMFR, and density are values measured by the measuring methods described in Examples to be described below.

The MFR of the ethylene-based polymer of the component (B) is 150 g/10 min or more and less than 400 g/10 min, preferably 180 to 300 g/10 min, further preferably 200 to 280 g/10 min. When the MFR of the component (B) is less than 150 g/10 min, there is a tendency that fluidity decreases and moldability becomes worse. When it exceeds 400 g/10 min, stress crack resistance tends to decrease.

The density of the component (B) is 0.960 or more. When the density of the component (B) is less than 0.960 g/cm³, there is a risk that rigidity decreases. An upper limit of the density of the component (B) is not particularly limited but is usually 0.980 g/cm³ or less.

(3) Requirements as Composition

With regard to the ratio of the component (A) and the component (B), the amount of component (A) is 20% by weight or more and less than 30% by weight, preferably 22 to 29% by weight and the amount of component (B) is more than 70% by weight and 80% by weight or less, preferably 71 to 78% by weight.

In this connection, the sum of the component (A) and the component (B) is fundamentally 100% by weight but the other any resin components and the like may be incorporated.

When the amount of the component (A) is less than 20% by weight, stress crack resistance decreases. When the amount of the component (B) is 70% by weight or less, moldability decreases. When it exceeds 80% by weight, stress crack resistance decreases.

The melt flow rate (MFR) of the polyethylene-based resin molding material at a temperature of 190° C. under a load of 2.16 kg is 0.4 g/10 min or more and less than 2.0 g/10 min, preferably 0.5 to 1.5 g/10 min, further preferably 0.7 to 1.2 g/10 min. When the MFR is less than 0.4 g/10 min, higher productivity at molding is poor. When it is 2.0 g/10 min or more, stress crack resistance of a container closure is poor.

The high load melt flow rate (HLMFR) is 70 g/10 min or more and less than 180 g/10 min, preferably, 80 to 140 g/10 min, further preferably 90 to 135 g/10 min. When the HLMFR is less than 70 g/10 min, higher productivity is poor. When it is 180 g/10 min or more, stress crack resistance of a container closure is poor.

The HLMFR/MFR is 100 to 200, preferably 105 to 170, further preferably 108 to 165. When the HLMFR/MFR is less than 100, higher productivity at molding becomes worse. When it exceeds 200, higher productivity at molding also becomes worse.

The density of the polyethylene-based resin molding material is 0.953 g/cm³ or more and less than 0.965 g/cm³, preferably 0.954 to 0.964 g/cm³, further preferably 0.955 to 0.963 g/cm³. When the density is less than 0.953 g/cm³, rigidity of a container closure is poor and the cap is apt to be deformed at high temperature, so that the container closure is deformed by the influence of inner pressure of the container, which may be a cause of leakage. When the density is 0.965 g/cm³ or more, stress crack resistance of the container closure is poor.

(4) Other Requirements as Composition

The flexural modulus of the polyethylene-based resin molding material is preferably 800 MPa or more, more preferably 850 MPa or more, further preferably 900 MPa or more. When the flexural modulus is less than 800 MPa, rigidity decreases and a container closure is apt to be deformed by the inner pressure of the container, particularly is apt to be deformed at high temperature. An upper limit of the flexural modulus is not particularly limited but is usually 2,000 MPa or less. In this connection, the flexural modulus is a value measured in accordance with JIS-K6922-2:1997 using a plate of 4×10×80 mm which is obtained by injection molding at 210° C. as a test piece.

The tensile strength at yield of the polyethylene-based resin molding material is preferably 25 MPa or more, more preferably 26 MPa or more, further preferably 27 MPa or more. When the tensile strength at yield is less than 25 MPa, cut feeling of bridge portion of a container closure is bad and appropriate hardness is insufficient. An upper limit of the tensile strength at yield is not particularly limited but is usually 50 MPa or less. In this connection, the tensile strength at yield is a value measured in accordance with JIS-K6922-2:1997.

The tensile strength at yield correlates to looseness of a container closure. When the tensile strength at yield is low, the container closure is apt to be loosened and easy closing property of appropriate hardness of the container closure is insufficient. For improving the stress crack resistance of the container closure, it is necessary to lower the density of the polyethylene-based material, so that it is difficult to improve the tensile strength at yield with improving the stress crack resistance. However, the present invention enables improvement of both of the looseness and the stress crack resistance of the container closure.

The hydrocarbon volatile matter content of the polyethylene-based resin molding material is desirably 80 ppm or less, preferably 50 ppm or less, further preferably 30 ppm or less. The hydrocarbons in the invention refer to compounds containing at least carbon and hydrogen in a molecule and they are usually measured by gas chromatography. By limiting the content to a predetermined value or less, influence of odor and flavor on the contents in the container can be prevented. In this connection, the hydrocarbon volatile matter content is obtained by placing 1 g of the polyethylene-based resin molding material in a 25 ml glass sealed container and measuring the air in the head space by gas chromatography after 60 minutes of heating at 130° C.

The time for break (FNCT) at 1.9 MPa by full notch creep test of the polyethylene-based resin molding material is preferably 90 hours or more, more preferably 120 hours or more, further preferably 130 hours or more. When the FNCT is less than 90 hours, it becomes highly probable that breakage by a stress crack during storage at high temperature in summer may occur. In this connection, the FNCT is measured in accordance with JIS-K6774:1998 at 80° C. using a 1% aqueous solution of Emal manufactured by Kao Corporation as a using liquid.

2. Production of Polyethylene-Based Resin Molding Material

(1) Production of Composition by Mixing or Sequential Multistage Polymerization

The composition comprising the component (A) and the component (B) can be obtained by mixing the ethylene-based polymer of the component (A) and the ethylene-based polymer of the component (B).

Preferably, for the reason of uniformity of the resin, the composition is obtained by polymerization of the ethylene-based polymer of the component (A) and the ethylene-based polymer of the component (B) in a sequential and continuous manner (sequential multistage polymerization method). For example, it is desirably obtained by polymerizing ethylene and an α-olefin in a sequential and continuous manner in a plurality of reactors connected in series.

The composition comprising the component (A) and the component (B) of the invention may be one obtained by mixing the component (A) and the component (B) after they are separately obtained by polymerization. Furthermore, the ethylene-based polymer of the component (A) or the component (B) may be composed of a plurality of components. The ethylene-based polymer may be a polymer obtained by sequential continuous polymerization using one kind of a catalyst in a multistage polymerization reactor, may be a polymer produced using two or more kinds of catalysts in a one-stage or multistage polymerization reactor, or may be a mixture of polymers obtained by polymerization using one kind or two or more kinds of catalysts.

The polymer of the invention can be produced by a production process such as a gas-phase polymerization process, a solution polymerization process, or a slurry polymerization process and, preferably, a slurry polymerization process is desired. Among the polymerization conditions of the ethylene-based polymer, polymerization temperature can be selected from the range of 0 to 300° C. In the slurry polymerization, the polymerization is carried out at a temperature lower than melting point of the forming polymer. Polymerization pressure can be selected from the range of atmospheric pressure to about 100 kg/cm². The polymer can be preferably produced by carrying out the slurry polymerization of ethylene and an α-olefin in a state substantially free from oxygen, water, and the like in the presence of an inert hydrocarbon solvent selected from aliphatic hydrocarbons such as hexane and heptane, aromatic hydrocarbons such as benzene, toluene, and xylene, and alicyclic hydrocarbons such as cyclohexane and methylcyclohexane.

In the slurry polymerization, the hydrogen fed to a polymerization reactor is consumed as a chain transfer agent to determine an average molecular weight of the ethylene-based polymer to be formed and also partially dissolves in the solvent, the hydrogen being discharged from the reactor. The solubility of hydrogen in the solvent is small and thus the hydrogen concentration is low in the vicinity of a polymerization active point of the catalyst unless a large amount of a gas phase is present in the polymerization reactor. Therefore, when the amount of hydrogen fed is changed, the hydrogen concentration in the vicinity of the polymerization active point of the catalyst rapidly changes and the molecular weight of the ethylene-based polymer formed changes following the amount of hydrogen fed for a short period of time. Accordingly, when the amount of hydrogen fed is changed in a short cycle, more homogeneous product can be produced. For such a reason, it is preferred to employ the slurry polymerization process as a polymerization process. Moreover, with regard to the mode of change in the amount of hydrogen fed, an effect of broadening molecular weight distribution is obtained in a discontinuously changing mode rather than a continuously changing mode.

In the ethylene-based polymer of the invention, it is important to change the amount of hydrogen fed but it is also important to suitably change the other polymerization conditions such as the polymerization temperature, the amount of a catalyst fed, the amount of an olefin such as ethylene fed, the amount of a comonomer such as 1-butene fed, the amount of the solvent fed, and the like simultaneously to the change in hydrogen or separately.

(3) Sequential Multistage Polymerization

The method of polymerization in a plurality of reactors connected in series in a sequential and continuous manner, so-called sequential multistage polymerization method may be carried out by any of a method wherein a high-molecular-weight component is produced in an initial polymerization zone (first-stage reactor), the resulting polymer is transferred into the next reaction zone (second-stage reactor), and a low-molecular-weight component is produced in the second-stage reactor or a method wherein a low-molecular-weight component is produced in an initial polymerization zone (first-stage reactor), the resulting polymer is transferred into the next reaction zone (second-stage reactor), and a high-molecular-weight component is produced in the second-stage reactor.

A specific preferable polymerization method is as follows. Namely, it is a method wherein a Ziegler catalyst containing a titanium-based transition metal compound and an organoaluminum compound and two reactors are used, ethylene and an α-olefin are introduced into a first-stage reactor to produce a low-density polymer as a high-molecular-weight component, the polymer taken from the first-stage reactor is transferred into a second-stage reactor, and ethylene and hydrogen are introduced into the second-stage reactor to produce a high-density polymer as a low-molecular-weight component.

Incidentally, in the case of multistage polymerization, with regard to the amount and properties of the ethylene-based polymer formed in the polymerization zones of the second stage or the following stages, the amount of the polymer formed in each stage is determined (which can be understood by unreacted gas analysis) and physical properties of each polymer taken out after each stage are measured. Then, the physical properties of the polymer formed in each stage can be determined based on an additive property.

(4) Polymerization Catalyst

As the polymerization catalyst for the ethylene-based polymer, various catalysts such as Ziegler catalysts, Philips catalysts, and metallocene catalysts are employed. As the polymerization catalyst, any catalysts can be used so far as they allow hydrogen to show chain transfer action of olefin polymerization.

Specifically, any catalysts can be used so far as they are composed of a soclosure catalyst component and an organometallic compound and are suitable for olefin polymerization by the slurry process so that hydrogen shows chain transfer action of olefin polymerization. Preferred is a heterogeneous catalyst wherein polymerization active points are localized. The above soclosure catalyst component is not particularly limited so far as it contains a transition metal compound and is used as a soclosure catalyst for olefin polymerization.

As the transition metal compound, a compound of a metal of Group IV to VIII metals, preferably Group IV to VI metals in the periodic table can be used. Specific examples thereof include compounds of Ti, Zr, Hf, V, Cr, Mo, and the like. Examples of preferred catalysts are soclosure Ziegler catalysts composed of a Ti and/or V compound and an organometallic compound of a metal of Group I to III metals in the periodic table. Furthermore, there is exemplified a combination of a complex wherein a ligand having a cyclopentadiene skeleton is coordinated to a transition metal, so-called metallocene catalyst with a co-catalyst. Specific metallocene catalysts include combinations of complex catalysts obtained by coordinating a ligand having a cyclopentadiene skeleton, such as methylcyclopentadiene, dimethylcyclopentadiene, or indene to a transition metal including Ti, Zr, Hf, a lanthanoid metal, or the like with organometallic compounds of Group I to III metals, such as aluminoxane as co-catalysts and supported type ones wherein these complex catalysts are supported on a support such as silica. Particularly preferred soclosure catalyst components for olefin polymerization include those containing at least titanium and/or vanadium and magnesium.

As the organometallic compound capable of being used together with the above soclosure catalyst component containing at least titanium and/or vanadium and magnesium, organoaluminum compounds, particularly trialkylaluminum are preferred. The amount of the organoaluminum compound to be used during the polymerization reaction is not particularly limited but usually, is preferably in the range of 0.05 to 1,000 mol relative to 1 mol of the titanium compound.

(5) Monomer for Polymerization

The ethylene-based polymers as the components (A) and (B) in the invention are obtained by homopolymerization of ethylene or by copolymerization of ethylene with an α-olefin having 3 to 12 carbon atoms, such as propylene, 1-butene, 1-pentene, 1-hexene, 4-methyl-l-pentene, or 1-octene.

It is also possible to carry out copolymerization with a diene in the case of aiming at modification. Examples of the diene compound to be used on this occasion include butadiene, 1,4-hexadiene, ethyclosureenenorbornene, dicyclopentadiene, and the like.

In this connection, comonomer content at the polymerization can be optionally selected but, for example, in the case of copolymerization of ethylene with an α-olefin having 3 to 12 carbon atoms, the α-olefin content in the ethylene/α-olefin copolymer is 0 to 40% by mol, preferably 0 to 30% by mol.

3. Material for Molding

The ethylene-based polymer produced by the above method can be transformed into a desired molded article suitably as a container closure by pelletization through mechanical melt mixing by means of a pelletizer, a homogenizer, or the like and subsequent molding by means of various molding machines according to conventional methods.

In order to improve various physical properties and impart the other physical properties, in addition to the other olefin-based polymers, rubbers, and the like, usual additives such as an antioxidant, a UV absorber, a light stabilizer, a lubricant, an antistatic agent, a defogging agent, an antiblocking agent, a processing aid, a coloring pigment, a crosslinking agent, a foaming agent, an inorganic or organic filler, and a flame retardant can be mixed into the ethylene-based polymer.

In the invention, it is also an effective method to use a nucleating agent in order to accelerate a crystallization rate. The nucleating agent is not particularly limited and a general organic or inorganic nucleating agent can be employed.

Specifically, the antioxidant (phenol-based, phosphorus-based, sulfur-based), lubricant, antistatic agent, light stabilizer, UV absorber, or the like may be used solely or in combination of two or more thereof. As the filler, it is possible to use calcium carbonate, talc, metal powders (aluminum, copper, iron, lead, etc.), silica, diatomaceous earth, alumina, gypsum, mica, clay, asbestos, graphite, carbon black, titanium oxide, and the like. Of these, it is preferred to use calcium carbonate, talc, mica, and the like. In every case, various additives can be mixed into the above polyethylene as needed and the resulting mixture can be kneaded in a kneading extruder, a Banbury mixer, or the like to form a material for molding.

4. Method for Controlling Values of Characteristic Properties in Polyethylene-based Resin Molding Material

(1) MFR and HLMFR

The MFR and HLMFR can be adjusted by temperature and use of a chain transfer agent in the polymerization of the ethylene-based monomer(s), whereby desired values can be obtained.

Namely, the molecular weight is lowered by elevating the polymerization temperature of ethylene with an α-olefin and, as a result, the MFR (HLMFR) and the like can be increased. By lowering the polymerization temperature, the molecular weight is increased and, as a result, the MFR and the like can be decreased. Also, by increasing the amount of hydrogen (amount of chain transfer agent) to be present in the copolymerization reaction of ethylene with an α-olefin, the molecular weight is lowered and, as a result, the MFR (HLMFR) and the like can be increased. By decreasing the polymerization temperature, the molecular weight is increased and, as a result, the MFR and the like can be decreased.

(2) HLMFR/MFR

The HLMFR/MFR (flow ratio, FLR) can be increased or decreased by adjusting molecular weight distribution. The HLMFR/MFR correlates to molecular weight distribution (weight-average molecular weight Mw/number-average molecular weight Mn) obtained by gel permeation chromatography and a value of 100 in HLMFR/MFR corresponds to a value of about 18 in the molecular weight distribution Mw/Mn. The HLMFR/MFR or Mw/Mn can be regulated by the kind of the catalyst, the kind of the co-catalyst, the polymerization temperature, the residence time in the polymerization reactor, the number of the polymerization reactors, and the like. It can be also regulated by the temperature, pressure, and shearing rate of the extruder and preferably, it can be increased or decreased by regulating the mixing ratio of the high-molecular-weight component and the low-molecular-weight component.

In particular, the HLMFR/MFR or Mw/Mn is apt to be influenced by the kind of the catalyst. In general, Philips catalysts result in a wide molecular weight distribution, metallocene catalysts result in a narrow molecular weight, and Ziegler catalysts result in an intermediate molecular weight distribution.

(3) Density

With regard to the density, a desired one can be obtained by changing the kind and amount of the comonomer to be copolymerized with ethylene.

(4) Control of Values of Other Characteristic Properties

The flexural modulus can be regulated by increasing or decreasing the molecular weight and density of the polyethylene. When the molecular weight or density is increased, the flexural modulus can be enhanced.

The tensile strength at yield can be regulated by increasing or decreasing the density. When the density is increased, the strength can be enhanced.

The lowering of the hydrocarbon volatile matter content to a determined value or lower can be achieved by subjecting the polyethylene-based polymer obtained by polymerization to a volatile matter-removing operation, e.g., a steam stripping treatment, a deodorizing treatment with warm air, a vacuum treatment, a nitrogen-purging treatment, or the like. Particularly, by carrying out the steam deodorizing treatment, the effect of the controlling operation can be remarkably achieved. The conditions for the steam treatment are not particularly limited but it is suitable to bring the ethylene-based polymer into contact with steam at 100° C. for about 8 hours.

The increase of the FNCT can be achieved by adding a low-density and high-molecular-weight component.

5. Utilization as Container Closure Member and the Like

Starting from the polyethylene-based resin molding material of the invention, it is molded mainly by injection molding, continuous compression molding, or the like to afford various molded articles, suitably such as a container closure member or a container per se.

The polyethylene-based resin molding material of the invention satisfies various characteristic properties and hence is excellent in moldability, high melt flow, odor, impact resistance, food safety, rigidity, and the like as well as is excellent in thermal resistance. Accordingly, the material is suitable in applications which require such properties, e.g., containers and container closures and is particularly suitable in an application for drinks such as carbonated drinks causing a high inner pressure.

In addition, it can be also used in applications of containers (e.g., packaging of food and/or beverage, bottle, and cup) and container closures (e.g., lid and cap) in foods and drinks such as edible oil, spices and condiments such as wasabi, seasonings, and alcoholic drinks and applications of containers and container closures for cosmetics, hair cream, and the like, which are mainly molded by injection molding.

In particular, the polyethylene-based resin molding material of the invention exhibits an excellent effect in container closures of liquids of carbonated drinks from the viewpoint of the pressure-resistant performance. The container closures for carbonated drinks using the material of the invention are capable of high-speed molding, higher output, and one-piece shaping and are most suitably employed for containers such as PET bottles.

### EXAMPLES

The following will explain the invention with reference to Examples and Comparative Examples and will evidence reasonableness and significance of the requirements in the constitution of the invention and superiority to conventional technologies. The measuring methods used in Examples are as follows.
(1) Melt flow rate (MFR) at a temperature of 190° C. under a load of 2.16 kg: it was measured in accordance with JIS-K6922-2:1997.
(2) High load melt flow rate (HLMFR) at a temperature of 190° C. under a load of 21.6 kg: it was measured in accordance with JIS-K6922-2:1997.
(3) Density: it was measured in accordance with JIS-K6922-1,2:1997.
(4) Molecular weight distribution (weight-average molecular weight Mw/number-average molecular weight Mn) by gel permeation chromatography: it was measured by gel permeation chromatography (GPC) under the following conditions.
Apparatus: 150 C manufactured by WATERS; Column: three columns of AD80M/S manufactured by Showa Denko K.K. Measuring temperature: 140° C.; Concentration: 1 mg/1 ml; Solvent: o-dichlorobenzene
(5) Time for break at 1.9 MPa by full notch creep test (FNCT) : it was measured at 80° C. using an aqueous 1% Emal (manufactured by Kao Corporation) solution in accordance with JIS-K6774:1998.
(6) Flexural modulus: it was measured using a plate of 4×10×80 mm obtained by injection molding at 210° C. as a test piece, in accordance with JIS-K6922-2:1997.
(7) Tensile strength at yield: it was measured in accordance with JIS-K6922-2:1997.
(8) Hydrocarbon volatile matter content: it was measured by placing one gram of the resin in a 25 ml glass sealed vessel, heating the whole at 130° C. for 60 minutes, and subsequently analyzing the content in the sealed vessel by gas chromatography.
(9) Higher productivity at molding: molding was performed at a molding temperature of 190° C. and a mold temperature of 40° C. using a cylindrical container closure-shaped mold having a diameter of 30φ and a height of 20 mm in IS-80 injection molding machine manufactured by Toshiba Machine Co., Ltd. and those exhibiting a cooling time of 6 second or less were marked ◯ and those which were soft within 6 seconds or adhered to the mold and were not able to be released therefrom owing to bad slipping ability with the mold were marked ×.
(10) Pressure retention test: a carbonated water whose carbon dioxide concentration is 2,250 ml per 500 ml was filled into a 500 ml PET bottle under a condition of 5° C., the bottle was tightly sealed with the container closure obtained by the molding described in the above (9), the bottle was stored under a state of heating at 50° C. and 60° C. for one month, and then the conditions of the container closure were observed.

### Example 1

(Production of Catalyst)

As a soclosure catalyst component, a Ti-based catalyst obtained by a dissolution-precipitation method was used. The production method is as follows. After the inside of a 1 L-volume three-necked flask fitted with a stirrer and a cooler was thoroughly replaced with nitrogen, 250 ml of dry hexane, 11.4 g of anhydrous magnesium chloride which had been subjected to pulverization treatment in a 3 L vibration mill beforehand, and 110 ml of n-butanol were placed therein and the whole was heated at 68° C. for 2 hours to form a homogeneous solution (1a). After the solution (la) was cooled to room temperature, 8 g of methylpolysiloxane whose kinetic viscosity at 25° C. was 25 cSt was added thereto and the whole was stirred for 1 hour to obtain a homogeneous solution (1b). After the solution (1b) was cooled with water, 50 ml of titanium tetrachloride and 50 ml of dry hexane were added dropwise thereto using a dropping funnel over a period of 1 hour to obtain a solution (1c). The solution (1c) was homogeneous and no complex of the reaction product was precipitated. The solution (1c) was subjected to a heating treatment at 68° C. for 2 hours under refluxing. After about 30 minutes from the beginning of the heating, precipitation of the reaction product complex (1d) was observed. The precipitate was collected, washed with 250 ml of dry hexane six times, and then dried with nitrogen gas to recover 19 g of the reaction product complex (1d). When the reaction product complex (1d) was analyzed, it contained 14.5% by weight of Mg, 44.9% by weight of n-butanol, and 0.3% by weight of Ti and the specific surface area was 17 m²/g. In a 1 L-volume three-necked flask fitted with a stirrer and a cooler, 4.5 g of the reaction product complex (1d) was placed under a nitrogen atmosphere. Then, 250 ml of dry hexane and 25 ml of titanium tetrachloride were added thereto, followed by 2 hours of a heating treatment at 68° C. After cooled to room temperature, the whole was washed with 250 ml of dry hexane six times and dried with nitrogen gas to recover 4.6 g of a soclosure catalyst component (1e). When the soclosure catalyst component (1e) was analyzed, it contained 12.5% by weight of Mg, 17.0% by weight of n-butanol, and 9.0% by weight of Ti and the specific surface area was 29 m²/g. When the soclosure catalyst component (1e) was observed on SEM, the particle diameter was uniform and had a nearly spherical shape.

(Production of Polymer)

First-stage polymerization was carried out under conditions of a total pressure of 1.3 MPa and an average residence time of 1.9 hours by feeding, to a 200 L-inner volume polymerization vessel as a first-stage reactor, a polymerization solvent (n-hexane) in a rate of 70 l/hr, hydrogen in a rate of 0.38 mg/hr, ethylene in a rate of 17.4 kg/hr, and 1-butene in a rate of 0.92 kg/hr at 70° C. and maintaining a hydrogen concentration of 0.35×10⁻³ wt %, an ethylene concentration of 0.18 wt %, a concentration ratio of hydrogen to ethylene of 0.0085, and a concentration ratio of butene to ethylene of 1.0 in a liquid phase while the soclosure catalyst component (1e) obtained in the above production of catalyst was fed continuously in a rate of 14.3 g/hr from a catalyst-feeding line, triethylaluminum (TEA) was fed continuously in a rate of 56 mmol/hr from an organometallic compound-feeding line, and polymerization contents were discharged in a necessary rate.

A portion of a polymerization product of the first-stage reactor was sampled and the results of measuring physical properties of the polymerization product were shown as component (A) in Table 2.

The whole amount of the slurry polymerization product formed in the first-stage reactor was introduced into a 400 L-inner volume second-stage reactor through a continuous tube having an inner diameter of 50 mm without further treatment. Then, second-stage polymerization was carried out under conditions of a total pressure of 1.1 MPa and an average residence time of 1.05 hours by feeding a polymerization solvent (n-hexane) in a rate of 100 l/hr, hydrogen in a rate of 34.9 g/hr, and ethylene in a rate of 42.6 kg/hr at 82° C. and maintaining a hydrogen concentration of 0.022 wt %, an ethylene concentration of 0.6 wt %, and a concentration ratio of hydrogen to ethylene of 0.56 in a liquid phase while contents in the polymerization vessel were discharged in a necessary rate.

The polymerization product discharged from the second-stage reactor was introduced into a flushing tank and the polymerization product was continuously taken out while unreacted gas was removed from a degassing line. The resulting polymer was subjected to a steam stripping treatment and, after pelletization by a pelletizer, the physical properties were evaluated. The results are shown in Table 2. In Table 2, the physical properties of the component (B) formed in the second-stage reactor were determined from the physical properties of the polyethylene composition as a final product and the physical properties of the component (A) obtained in the first-stage reactor by calculation based on an additive property rule. As is apparent from Table 2, the resulting polymer had a large tensile strength at yield and was excellent in mechanical properties such as flexural modulus, so that it was excellent in suitability for container closure which requires durability and the like.

### Examples 2 to 4

Operations were carried out in the same manner as in Example 1 with the exception of the conditions shown in Table 1. Evaluation results of the resulting polymers are shown in Table 2. The resulting polymers had a large tensile strength at yield and was excellent in mechanical properties such as flexural modulus, so that it was excellent in suitability for container closure which requires durability and the like.

### Comparative Examples 1 to 7

Operations were carried out in the same manner as in Example 1 with the exception of the conditions shown in Table 1. Evaluation results of the resulting polymers are shown in Table 2. From Table 2, since the tensile strength at yield was small and the FNCT was insufficient in Comparative Example 1, a crack was formed in the continuous pressure resistance test at 60° C. In Comparative Example 2, the FNCT was large and the continuous pressure resistance test was passed but the tensile strength at yield was small, so that the suitability for container closure was insufficient. In Comparative Example 3, the tensile strength at yield was large but the FNCT was insufficient, so that a crack was formed in the continuous pressure resistance test at 60° C. In Comparative Examples 4 and 5, the tensile strength at yield was large but the FNCT was small, so that a crack was formed even in the continuous pressure resistance test at 50° C. In Comparative Example 6, since the density was small and the flexural modulus and tensile strength at yield were small, the suitability for container closure was insufficient. In Comparative Example 7, the tensile strength at yield was large but the FNCT was small, the hydrocarbon volatile matter content was large, and a crack was formed even in the continuous pressure resistance test at 50° C.

TABLE 1

| | Unit | Example 1 | Example 2 | Example 3 | Example 4 | Co. Ex. 1 |
|---|---|---|---|---|---|---|
| First-stage reactor | | | | | | |
| Amount of polymerization | l/hr | 70 | 70 | 70 | 70 | 70 |
| solvent | | | | | | |
| Amount of ethylene | Kg/hr | 17.4 | 15.0 | 15.0 | 12.6 | 16.2 |
| Amount of 1-butene | Kg/hr | 0.92 | 0.66 | 0.66 | 0.55 | 0.94 |
| Amount of hydrogen | Mg/hr | 0.38 | 0.14 | 0.12 | 0.09 | 0.39 |
| Content of soclosure | g/hr | 14.3 | 14.3 | 14.3 | 14.3 | 14.3 |
| catalyst | | | | | | |
| Amount of triethyl- | Mmol/hr | 56 | 56 | 56 | 56 | 56 |
| aluminum | | | | | | |
| Hydrogen concentration in | Wt % | 0.35 | 0.13 | 0.11 | 0.09 | 0.37 |
| liquid phase × 10³ | | | | | | |
| Ethylene concentration | Wt % | 0.18 | 0.16 | 0.16 | 0.14 | 0.17 |
| Concentration ratio of | — | 0.0085 | 0.0036 | 0.0031 | 0.0028 | 0.0094 |
| hydrogen to ethylene | | | | | | |
| Concentration ratio of | — | 1.00 | 0.83 | 0.83 | 0.83 | 1.10 |
| butene to ethylene | | | | | | |
| Polymerization | ° C. | 70 | 70 | 70 | 70 | 70 |
| temperature | | | | | | |
| Polymerization pressure | MPa | 1.3 | 1.3 | 1.3 | 1.3 | 1.4 |
| Average residence time | min | 116 | 120 | 120 | 125 | 118 |
| Second-stage reactor | | | | | | |
| Amount of polymerization | l/hr | 100 | 100 | 100 | 100 | 100 |
| solvent | | | | | | |
| Amount of ethylene | Kg/hr | 42.6 | 45.0 | 45.0 | 47.4 | 43.8 |
| Amount of hydrogen | g/hr | 34.9 | 27.9 | 27.9 | 56.9 | 80.0 |
| Content of soclosure | g/hr | 0 | 0 | 0 | 0 | 0 |
| catalyst | | | | | | |
| Amount of triethyl- | Mmol/hr | 0 | 0 | 0 | 0 | 0 |
| aluminum | | | | | | |
| Hydrogen concentration in | Wt % | 0.022 | 0.017 | 0.017 | 0.034 | 0.050 |
| liquid phase × 10³ | | | | | | |
| Ethylene concentration | Wt % | 0.60 | 0.62 | 0.62 | 0.64 | 0.61 |
| Concentration ratio of | — | 0.56 | 0.42 | 0.42 | 0.82 | 1.25 |
| hydrogen to ethylene | | | | | | |
| Polymerization | ° C. | 82 | 82 | 82 | 82 | 82 |
| temperature | | | | | | |
| Polymerization pressure | MPa | 1.1 | 1.1 | 1.1 | 1.1 | 1.2 |
| Average residence time | min | 63 | 63 | 63 | 63 | 63 |
| | Co. Ex. 2 | Co. Ex. 3 | Co. Ex. 4 | Co. Ex. 5 | Co. Ex. 6 | Co. Ex. 7 |
| First-stage reactor | | | | | | |
| Amount of polymerization | 70 | 70 | 70 | 70 | 70 | 50 |
| solvent | | | | | | |
| Amount of ethylene | 13.8 | 15.0 | 15.0 | 15.0 | 10.8 | 20.0 |
| Amount of 1-butene | 0.80 | 0.87 | 0.08 | 0.14 | 0.5 | 0.32 |
| Amount of hydrogen | 0.33 | 0.35 | 6000 | 4980 | 0.05 | 2.2 |
| Content of soclosure | 14.3 | 14.3 | 3.5 | 5.0 | 14.3 | 9.5 |
| catalyst | | | | | | |
| Amount of triethyl- | 56 | 56 | 25 | 25 | 56 | 56 |
| aluminum | | | | | | |
| Hydrogen concentration in | 0.32 | 0.34 | 6.73 | 5.58 | 0.05 | 1.60 |
| liquid phase × 10³ | | | | | | |
| Ethylene concentration | 0.15 | 0.16 | 0.16 | 0.16 | 0.12 | 0.20 |
| Concentration ratio of | 0.0093 | 0.0091 | 0.2734 | 0.2269 | 0.0018 | 0.043 |
| hydrogen to ethylene | | | | | | |
| Concentration ratio of | 1.10 | 1.10 | 0.10 | 0.18 | 0.89 | 0.30 |
| butene to ethylene | | | | | | |
| Polymerization | 70 | 70 | 82 | 82 | 70 | 70 |
| temperature | | | | | | |
| Polymerization pressure | 1.4 | 1.3 | 1.1 | 1.1 | 1.4 | 1.4 |
| Average residence time | 122 | 120 | 120 | 120 | 130 | 148 |
| Second-stage reactor | | | | | | |
| Amount of polymerization | 100 | 100 | — | — | 100 | 100 |
| solvent | | | | | | |
| Amount of ethylene | 43.8 | 45.0 | — | — | 49.2 | 20.0 |
| Amount of hydrogen | 80.0 | 27.9 | — | — | 90.5 | 25.3 |
| Content of soclosure | 0 | 0 | — | — | 0 | 0 |
| catalyst | | | | | | |
| Amount of triethyl- | 0 | 0 | — | — | 0 | 0 |
| aluminum | | | | | | |
| Hydrogen concentration in | 0.050 | 0.017 | — | — | 0.054 | 0.034 |
| liquid phase × 10³ | | | | | | |
| Ethylene concentration | 0.61 | 0.62 | — | — | 0.65 | 0.64 |
| Concentration ratio of | 1.25 | 0.42 | — | — | 1.26 | 0.82 |
| hydrogen to ethylene | | | | | | |
| Polymerization | 82 | 82 | — | — | 82 | 82 |
| temperature | | | | | | |
| Polymerization pressure | 1.2 | 1.1 | — | — | 1.2 | 0.9 |
| Average residence time | 63 | 63 | — | — | 63 | 91 |

Co. Ex.: Comparative Example

TABLE 2

| | | | Exam- | Exam- | Exam- | Exam- | Co. | Co. | Co. | | | | |
|---|---|---|---|---|---|---|---|---|---|---|---|---|---|
| | | Unit | ple 1 | ple 2 | ple 3 | ple 4 | Ex. 1 | Ex. 2 | Ex. 3 | Co. Ex. 4 | Co. Ex. 5 | Co. Ex. 6 | Co. Ex. 7 |
| Com- | HLMFR | g/10 min | 0.4 | 0.2 | 0.2 | 0.1 | 1.0 | 1.0 | 0.9 | 300 | 1650 | 0.1 | 8.5 |
| ponent | Density | g/cm³ | 0.921 | 0.921 | 0.919 | 0.911 | 0.924 | 0.924 | 0.923 | 0.962 | 0.961 | 0.890 | 0.947 |
| (A) | Comonomer | — | butene- | butane- | butene- | Butane- | butene- | butane- | butane- | butane-1 | butene-1 | butane-1 | butane-1 |
| | | | 1 | 1 | 1 | 1 | 1 | 1 | 1 | | | | |
| Com- | MFR | g/10 min | 230 | 200 | 200 | 300 | 600 | 600 | 200 | — | — | 700 | 330 |
| ponent | Density | g/cm³ | 0.970 | 0.970 | 0.970 | 0.970 | 0.965 | 0.965 | 0.968 | — | — | 0.963 | 0.970 |
| (B) | | | | | | | | | | | | | |
| Whole | Component | % by | 29 | 25 | 25 | 21 | 27 | 23 | 25 | 100 | 100 | 18 | 55 |
| entity | (A) | weight | | | | | | | | | | | |
| | Component | % by | 71 | 75 | 75 | 79 | 73 | 77 | 75 | 0 | 0 | 82 | 45 |
| | (B) | weight | | | | | | | | | | | |
| | MFR | g/10 min | 1.2 | 0.8 | 0.7 | 0.8 | 2.8 | 3.3 | 1.8 | 8.0 | 55.0 | 2.0 | 1.5 |
| | HLMFR | g/10 min | 130 | 130 | 110 | 160 | 360 | 310 | 270 | 300 | 1650 | 370 | 124 |
| | HLMFR/ | — | 108 | 163 | 157 | 200 | 129 | 94 | 150 | 38 | 30 | 185 | 82 |
| | MFR | | | | | | | | | | | | |
| | Density | g/cm³ | 0.956 | 0.958 | 0.957 | 0.958 | 0.955 | 0.953 | 0.957 | 0.962 | 0.962 | 0.950 | 0.958 |
| | Flexural | MPa | 850 | 900 | 870 | 900 | 780 | 700 | 830 | 1000 | 980 | 670 | 900 |
| | modulus | | | | | | | | | | | | |
| | Tensile | MPa | 25 | 27 | 26 | 27 | 23 | 22 | 26 | 29 | 28 | 21 | 25 |
| | strength at | | | | | | | | | | | | |
| | yield | | | | | | | | | | | | |
| | FNCT | hour | 90 | 125 | 135 | 102 | 85 | 150 | 70 | 1 | 0.5 | 90 | 20 |
| | Hydrocarbon | ppm | 23 | 25 | 21 | 28 | 27 | 28 | 22 | 23 | 15 | 28 | 280 |
| | volatile | | | | | | | | | | | | |
| | matter | | | | | | | | | | | | |
| | content | | | | | | | | | | | | |
| Molded | Higher | — | ◯ | ◯ | ◯ | ◯ | ◯ | ◯ | ◯ | ◯ | X | ◯ | X |
| article | productivity | | | | | | | | | | | | |
| | Pressure | — | Nothing | Nothing | Nothing | Nothing | Nothing | Nothing | Nothing | Crack | Crack | Nothing | Crack |
| | retention | | peculiar | peculiar | peculiar | peculiar | peculiar | peculiar | peculiar | formation | formation | peculiar | formation |
| | test (50° C.) | | | | | | | | | | | | |
| | Pressure | — | Nothing | Nothing | Nothing | Nothing | Crack | Nothing | Crack | Crack | Crack | Crack | Crack |
| | retention | | peculiar | peculiar | peculiar | peculiar | forma- | peculiar | forma- | formation | formation | formation | formation |
| | test (60° C.) | | | | | | tion | | tion | | | | |

Co. Ex.: Comparative Example, and “Pressure retention test (50° C.)” and “Pressure retention test (60° C.)” showed a result condition observed

[Considerations by Comparison of Results in Examples and Comparative Examples]

As above, in Examples 1 to 4, it was clear that the higher productivity, pressure resistance, durability, and the like are excellent when the polyethylene-based resin materials satisfying various requirements of characteristic properties of the invention are used as cap materials for containers for drinks and the like.

In Comparative Example 1, since the MFR of the component (B) is too high and the MFR and HLMFR of the composition are also too high, the tensile strength at yield is small and the FNCT is insufficient, so that a crack is formed in the pressure retention test at 60° C. In Comparative Example 2, the MFR of the component (B) is too high, the MFR and HLMFR of the composition are also too high, and the FLR is too low, the tensile strength at yield decreases and the suitability for container closure is insufficient. In Comparative Example 3, since the HLMFR of the composition is too high, the FNCT is insufficient, so that a crack is formed in the pressure retention test at 60° C. In Comparative Example 4, since the HLMFR and density of the component (A) is too high, the component (B) is not contained, the whole MFR and HLMFR are also too high, and the FLR is too low, the FNCT is insufficient, so that a crack is formed in the pressure retention test at 50° C. and 60° C. In Comparative Example 5, since the HLMFR and density of the component (A) is too high, the component (B) is not contained, the whole MFR and HLMFR are also too high, and the FLR is too low, the FNCT is insufficient and thus a crack is formed in the pressure retention test at 50° C. and 60° C. as well as the higher productivity is also poor. In Comparative Example 6, the density of the component (A) is too low, the MFR of the component (B) is too high, the amount of the component (A) in the composition is insufficient, the HLMFR is also too high, and the density is also too low, the tensile strength at yield is low and a crack is formed in the continuous pressure resistance test at 60° C. In Comparative Example 7, since the HLMFR of the component (A) is too high, the composition ratio of the component (A) is high and the HLMFR/MFR of the composition are also small, the FNCT is insufficient, so that a crack is formed in the continuous pressure resistance test at 50° C. and 60° C. as well as the higher productivity is also poor.

As above, the reasonableness and significance of the requirements in the constitution of the invention and the superiority of the invention to conventional technologies are evidenced.

This application is based on Japanese patent application JP 2006-194941, filed on July 14, 2006, the entire content of which is hereby incorporated by reference, the same as if set forth at length.

What is claimed is:

1. A polyethylene-based resin molding material, which is a composition comprising: the following component (A) in an amount of 20% by weight or more and less than 30% by weight; and the following component (B) in an amount of more than 70% by weight and 80% by weight or less, wherein the polyethylene-based resin molding material satisfies the following characteristic properties (1) and (2):
component (A): an ethylene-based polymer having a high load melt flow rate (HLMFR) at a temperature of 190° C. under a load of 21.6 kg of 0.1 to 1.0 g/10 min and a density of 0.910 to 0.930 g/cm³;
component (B): an ethylene-based polymer having a melt flow rate (MFR) at a temperature of 190° C. under a load of 2.16 kg of 150 g/10 min or more and less than 400 g/10 min and a density of 0.960 g/cm³ or more, characteristic property(l): an MFR of 0.4 g/10 min or more and less than 2.0 g/10 min, an HLMFR of 70 g/10 min or more and less than 180 g/10 min, and an HLMFR/MFR of 100 to 200;
characteristic property(2): a density of 0.953 g/cm³ or more and less than 0.965 g/cm³.

2. The polyethylene-based resin molding material according to claim 1, which satisfies the following characteristic properties (3) and (4):
characteristic property (3): a flexural modulus of 800 MPa or more;
characteristic property (4): a tensile strength at yield of 25 MPa or more.

3. The polyethylene-based resin molding material according to claim 1, wherein the ethylene-based polymer (A) is a copolymer of ethylene and an α-olefin.

4. The polyethylene-based resin molding material according to claim 1, which has a hydrocarbon volatile matter content of 80 ppm or less.

5. The polyethylene-based resin molding material according to claim 1, wherein the composition constituting the polyethylene-based resin molding material is produced by sequential multistage polymerization of ethylene, or ethylene and an α-olefin.

6. A container closure, which comprises the polyethylene-based resin molding material according to claim 1.

7. The container closure according to claim 6, wherein the container closure is a cap for a container for a carbonated drink.
